(19) United States
(12) Patent Application Publication
(10) Pub. No.: US 2003/0117730 A1
(43) Pub. Date: Jun. 26, 2003

(54) Ultra lightweight and ultra rigid solid ceramic reflector and method of making same

(76) Inventors: Matthias Kroedel, Ottobrunn (DE); Fred Ziegler, Taufkirchen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/152,976

(22) Filed: May 23, 2002

(30) Foreign Application Priority Data
May 23, 2001 (DE) 101 25 554.3

(51) Int. Cl. G02B 5/08

(52) U.S. Cl. 359/848; 359/883

(57) ABSTRACT

An ultra fine and ultra rigid solid ceramic reflector, as well as a process for manufacturing a reflector, whereby ceramic material is applied on a first surface of a ceramic faceplate, preformed in accordance with the contour of the reflector, and is connected monolithically to the faceplate.

### BACKGROUND AND SUMMARY OF THE INVENTION

This application claims the priority of German Patent Document No. 101 25 554.3, filed May 23, 2001, the disclosure of which is expressly incorporated herein by reference.

Due to the steadily increasing requirements placed on new, larger, highly complex, and efficient reflectors it is necessary that these reflectors be made lighter, more rigid, and more efficient. One way to meet these requirements is to make reflectors of ceramic materials.

To date, ceramic reflectors were made primarily of glass or glass ceramics, sintered silicon carbide or C/SiC. These reflectors are made of a thick plate, from which triangular or hexagonal or similar structures are milled in order to produce reflectors with a minimum weight per unit area to meet the requirements. In particular, in the case of glass, the machining is very time consuming and thus also very expensive. The reflectors take a long time to make because they can only be shaped very slowly, the shaping also requires expensive special tools.

In the case of sintered SiC and C/SiC the structure is machined in the so-called green state, that is in a relatively soft state so that the machining is significantly simpler and more economical. In the case of sintered SiC, however, there is considerable shrinkage in the sintering process. The shrinkage is not precisely constant and thus results in significantly more reworking in the ceramic state than in the case of C/SiC. In contrast to glass, SiC ceramics exhibit a thermal conductivity that is up to 100 times better and a significantly higher specific rigidity. These features predestine these materials for highly rigid reflectors.

As disclosed in DE 42 07 009 C2 and DE 43 29 551 A1, C/SiC reflectors are made of a porous carbon substrate and are machined into the necessary end shape by mechanical processing, in particular by milling.

The above-noted process is not only time consuming, but there also is a risk that, especially in the case of reflectors, which are supposed to exhibit an extremely low weight-per-unit-area of significantly less than 15 kg/m² or even less than 10 kg/m², the structure will be damaged during mechanical processing. This damage can result in a significant deterioration of the material properties, or the desired weight per unit area cannot be achieved at all. In this respect the weight per unit area is defined as the mass per unit area, for reflectors the thickness of the reflector and its area are in a defined relation to each other. Thus, for example, in general at an accuracy of the reflector contour of 8/10, a thickness of the reflector is chosen that is not less than one-tenth of the diameter of the reflector.

As disclosed in DE 42 07 009 C2, ceramic honeycomb structures can be connected to a dense top coating made of carbon fabric prepregs; and thus a lightweight construction can be achieved. This technique has the decisive drawback that under precise thermal cycles the thermo-mechanical properties of the material of the honeycomb and of the top coating are incompatible, a feature that results in delamination and/or cracks; and in addition the thermal conductivity of the top coating is very low.

Another possibility for producing lightweight reflectors is described in U.S. Pat. No. 6,206,531, where the use of a core structure made of foam is proposed. To produce the entire reflector a relatively expensive coating structure has to be produced. Even in the case of a reflector that is produced in this manner, the layers can still detach from each other owing to the different expansion properties, a state that is also the case in the DE 42 07 009.

The object of the present invention is to provide a less error-prone lightweight and rigid reflector as well as an improved process for its manufacture. This problem is solved by the means described below.

The invention comprises a reflector, made of a ceramic material with a low weight per unit area. The ceramic material is applied on a first surface of a ceramic faceplate, which is preformed, according to the desired contour of the reflector. Thus, a defined contour of the reflector can be achieved in a simple manner. In addition, it is provided that the ceramic material is connected monolithically to the faceplate, whereby the faceplate and the ceramic material have largely the same thermal properties. The source of error for a possible delamination of the different layers of a reflector structure which can occur, such as described in U.S. Pat. No. 6,206,531, is avoided. To obtain an especially lightweight. and yet rigid construction, the invention provides a C/SiC foam for the ceramic material. A C/SiC faceplate is provided as the ceramic faceplate. Since both the foam and the faceplate are made of C/SiC and they are connected monolithically, there are no different layers of material with different thermal properties. That is, there is no risk of the different layers of material detaching from each other or the risk of cracks forming owing to the different expansion properties.

Furthermore, the first surface of the faceplate can exhibit elevations and/or depressions made of C/SiC. They can serve either to produce, by means of interdigitation with the ceramic material, an improved connection between the faceplate and the ceramic material. Alternatively, they can contribute, for example, in the form of ribs or channels to improve thermal properties by forming passages for a gaseous or fluid cooling medium. Since the ceramic material is designed as a porous material, namely as foam, and thus exhibits a degree of permeability, this material itself can be used, in accordance with its permeability, as a passage for a thermostating medium. Therefore, it can be provided that heat is exchanged between the ceramic material and a thermostating medium. A ceramic foam with or without a rib or channel structure can be used as the integral heat exchanger of the reflector for transferring heat, for example, from the mirror surface to a cooling medium of gas or liquid. Conversely, the reflector structure can be heated by means of a thermostating medium.

To achieve an additional weight reduction of the reflector structure at largely constant rigidity, a C/SiC backplate can be provided on the ceramic material, the C/SiC foam. Then, the entire structure can be made correspondingly thinner. To rule out possible sources of error owing to the different layers of the structure, it is provided that the C/SiC backplate is connected monolithically to the C/SiC foam. In principle, elevations and/or depressions can also be provided for the backplate, analogous to the faceplate, as a function of the requirement.

Due to the uniform reinforcement of the reflector structure, as provided by the invention precisely for the case of a porous C/SiC foam as the ceramic material, the mirror surface can be ground and polished, as compared to the prior art, without disturbing quilting effects, thus without a local bulging of the reflector structure. Such effects result from grinding and polishing structures and are described in DE 42 07 009, regarding ceramic materials with a honeycomb structure or similar reinforcing ribs. During grinding or polishing the amount of material removed over the reinforcing ribs is then greater owing to the higher rigidity of the structure in these areas than over the areas between the reinforcing ribs, since in these other areas the structure is more flexible owing to a degree of flexibility of the material that is usually specified. Hence in these other areas the material gives way in the downward direction under the polishing pressure. Upon removal of the polishing pressure, buckles appear in these other areas. This feature is avoided precisely with the use of a C/SiC foam.

Furthermore, it can be provided that a grindable and polishable surface coating is applied on the C/SiC faceplate; and the surface coating is connected monolithically to the C/SiC faceplate. Thus, it is achieved, on one hand, that the surface of the reflector can be ground directly and polished to the requisite roughness, in particular to achieve as low a scattered light level as possible. The monolithic connection prevents in turn possible sources of error. Due to the monolithic connection of all of the important components of the reflector the goal is reached that the entire reflector, including the polished mirror surface, is made of one monolithic material. Therefore there are no different layers with different material properties that can act as sources of error.

The invention further comprises a process for manufacturing a reflector, whereby a ceramic material with low weight per unit area is applied on a first surface of a ceramic faceplate, which is preformed according to the contour of the reflector, and whereby then the ceramic material is connected monolithically to the faceplate. The invention provides that first a polymeric foam structure is coated with a suspension comprising a ceramic starting material, which contains silicon. The polymeric structure can be coated with the suspension, for example, by dipping into the suspension or through utilization of capillary effects using a porous polymeric structure. Then, to produce a ceramic intermediate product with a foam structure, the foam structure treated thus is pyrolyzed in the absence of oxygen. The polymeric structure is destroyed through pyrolysis; what remains is a ceramic intermediate product that has largely the structure of the polymeric structure prior to its pyrolysis. Following pyrolysis, the ceramic intermediate product is applied on a carbon/carbon faceplate. This step is followed by an infiltration of a silicon-containing material at temperatures exceeding 1,350° C. to produce a monolithic C/SiC structure comprising a C/SiC foam and a C/SiC faceplate. Thus, a monolithic connection of the individual components of the reflector is obtained; and the result is the final ceramic material. The appropriate choice of materials, as presented here, for the ceramic material or the ceramic intermediate product—the faceplate, the backplate—contributes to this monolithic connection. The advantages of such a process have already been explained above with reference to the reflector system that can be made with such a process.

Furthermore, it can be provided that, prior to applying the foam on the first surface of the faceplate, elevations and/or depressions can be produced from the same material as that of the faceplate. The possible applications for such elevations and/or depressions have also been already explained. In addition, for additional reinforcement, a carbon/carbon backplate can be put on the foam, whereby the carbon/carbon backplate is connected monolithically to the foam through the infiltration of the silicon-containing material. In addition, a grindable and polishable surface coating can be applied on the C/SiC faceplate; and the surface coating can be connected monolithically to the C/SiC faceplate. The advantages of these possible measures have also been already explained with reference to the reflector system of the invention.

Furthermore, a special further development of the invention provides that the polymeric structure is coated with a special suspension comprising a suspension of SiC, silicon and carbon in an organic liquid mixture.

In particular it can be provided for the manufacturing process that, following pyrolysis, the ceramic intermediate product is connected to the faceplate and/or to the backplate by means of an adhesive. The adhesive contains preferably silicon carbide and/or carbon and/or silicon. Then the next step is the already described infiltration of a silicon-containing material at temperatures exceeding 1,350° C. Then the suitable choice of the adhesive can contribute to the realization of the already described monolithic connection.

Other objects, advantages and novel features of the present invention will become apparent from the following detailed description of the invention when considered in conjunction with the accompanying drawings.

### BRIEF DESCRIPTION OF THE DRAWINGS

FIG. 1 is a cross-sectional view of a reflector, according to the invention; and

FIG. 2 depicts an enlarged detail of a cross section taken from FIG. 1.

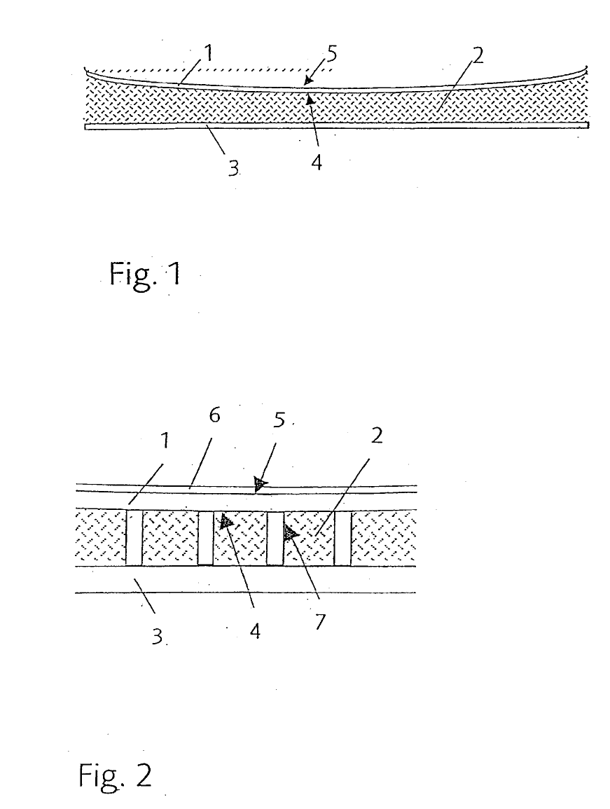

### DETAILED DESCRIPTION OF THE INVENTION

In the process, according to the present invention, a ceramic foam 2 is connected at least to a ceramic faceplate 1; or during the manufacture of the foam structures 2 the faceplate 1 is integrated directly into the respective foam structure 2.

A porous polymeric structure, preferably polyurethane in the form of a foam skeleton or any other burn-out agent, such as a polyamide granulate, is used as the starting material for the production of the ceramic foam. This starting material is dipped either into a suspension of a ceramic starting material, a procedure that can take place in a single process step or in several immersion steps; or such a suspension infiltrates the polymeric structure, for example, utilizing capillary effects. Then the structure is dried at temperatures ranging from 100° C. to 160° C.

What is important in this process is that the components of the suspension contain materials or consist of the same materials as the ceramic faceplate 1, which still has to be put on. For this purpose a suspension is used that comprises a slurry comprising a suspension of fine SiC, Si and carbon in an organic liquid mixture. Such a suspension can be produced, in particular, according to the following individual steps.

With the addition of the binder, the silicon carbide powder is mixed. The viscosity is set to an aqueous consistency with the addition of solvent. Preferably an organic solvent, for example a mixture comprising isopropyl alcohol, butylacetate, butanediol and polyethylene glycol, is used as the solvent; with phenolic resin or novolak resins used as the binder. This mixture is dispersed while stirring continuously. Following the homogenization period, the carbon, preferably in the form of ultra fine graphite and/or carbon black and/or carbon fibers is added. At this stage the entire system is dispersed in a conventional homogenizer. As the last step, more silicon is added for specific applications in order to guarantee, especially in the case of integral structures, that the foam structure is totally ceramized in the subsequent thermal process of the liquid infiltration.

After the foam structure has hardened, the polymeric structure is pyrolyzed in the absence of oxygen, preferably under nitrogen or under a vacuum, in a thermal process ranging from 900° C. to 1,200° C., ideally at approximately 1,000° C. The slurry transforms into a ceramic intermediate product, which is hard at room temperature, but exhibits a degree of flexibility at temperatures higher than 50° C.

Following pyrolysis, the ceramic intermediate product, which already has a foam structure, is connected firmly to a faceplate 1 and/or backplate 3 made of a carbon-carbon material. The faceplate 1 already has ideally at least substantially the desired surface contour of the subsequent reflector. The backplate 3 is optional and can be provided for additional reinforcement of the structure. Similarly, there can also be in principle additional side plates. The plates 1, 3 are connected to the ceramic intermediate product by means of an adhesive, which comprises a binder and at least silicon carbide, and preferably also carbon. Thus, the adhesive contains at least substantially the same substances as the foam structure. Thus, it is guaranteed that the adhesive, the intermediate product and/or the foam structure do not behave differently in the following described thermal process, a state that could otherwise result in disturbing phenomena, like the formation of cracks or shrinkage.

For constructive and/or thermal reasons, the ribs or the channel structures 7 can also be provided on the rear side of the faceplate 1 and/or the backplate 3; and in this case the foam segments of the intermediate product are cemented into the corresponding segments of the faceplate 1 and/or the backplate 3. Then the cemented structures are hardened at temperatures ranging from 70° C. to 170° C.

Following hardening of the structure, it is infiltrated with silicon under a vacuum at temperatures ranging from 1,350° C. to 1,700° C., ideally at approximately 1,600° C. Thus, a ceramic C/SiC structure exhibiting virtually no shrinkage, as compared to the sintering techniques of monolithic ceramic, is produced from the carbon/carbon structure of plates 1, 3, and also from the ceramic intermediate product and the adhesive. In this respect a monolithic structure, comprising the C/SiC faceplate 1 with C/SiC foam 2, with possible additional C/SiC plates as the backplate 3 and side plates, is produced from the cemented structure. The weight per unit area and the rigidity of the reflector can be set and optimized by varying the porosity of the original foam structure.

Following the infiltration process, the structure is cleaned, preferably by means of grit blasting so that the result is a smooth surface without any excess silicon from the previous process. At this stage the later reflection surface 5 is coarsely pre-ground largely according to the desired end shape. This preliminary grinding is supposed to guarantee in essence that the desired contour of the reflecting layer of the reflector is met.

Following preliminary grinding, at least the surface 5 is provided with a coating 6. For this purpose, any coating suitable for manufacturing a grindable and polishable surface, in particular a coating that can be connected monolithically to the faceplate 1 and includes material similar to that of the faceplate 1, can be provided in principle. A special process for producing such a coating is described below.

To produce the coating 6, a slurry is produced in the form of a dispersion, which consists of a binder, solvent, metallic and/or ceramic powder as well as carbon. Thus, the C/SiC faceplate 1 can be coated in such a manner that in the subsequent polishing sequences an RMS surface roughness of <1 μm, preferably even less than 10 nm, can be obtained.

The dispersion for the ceramic coating is produced according to the individual steps described below.

The silicon carbide powder is mixed with the binder. The viscosity of the two material mixture comprising silicon carbide powder and binder is set to an oily consistency with the addition of the solvent. Preferably, an organic solvent, for example, a mixture comprising isopropyl alcohol, butyl acetate, butanediol and polyethylene glycol, is used as the solvent. This oily mixture is dispersed using a conventional homogenizer. After the homogenization period; carbon, preferably in the form of ultra fine graphite or carbon black, is added. After this addition, the material system is now dispersed in turn in the homogenizer. As the last step the metallic powder, preferably metallic silicon, is added and the entire material system is homogenized. During the final homogenization process, solvent can be added continuously in order to set the viscosity required for the later application. The viscosity depends in essence on the coating process, with which the substrate, in particular the faceplate 1 and optionally also the backplate 3, are supposed to be subsequently coated. During the homogenization process, the viscosity is checked preferably with suitable measuring methods, such as with a conventional viscosimeter or flow cup.

The slurry dispersion can be applied using an injection technique, preferably by means of varnishing tools, whereby a separation of the dispersion is counteracted ideally with suitable tools in order to avoid nonhomogeneity at individual points between the coating and the substrate and/or voids in the coating.

The coating can be done in several individual steps, that is, the entire coating can be applied in several layers, instead of one single layer. Thus, individual layers of up to 0.5 mm can be obtained. After each coating sequence, the respective layer can be preferably dried. Such a drying operation can take place, for example, in a corresponding dryer cabinet. The drying period depends essentially on the layer thickness and the number of layers that have already been applied. The drying time between the individual coatings can range, for example, from 30 minutes to 120 minutes. The drying temperature is ideally less than 150° C. and may range, for example, from 70° C. to 120° C.

As soon as the coating 6 is finished the coated substrate is heated in a thermal process to temperatures exceeding 1,600° C. under a vacuum or protective gas. In this thermal process, analogous to the above described process, silicon carbide, largely β-SiC, is formed owing to the reaction affinity between silicon and carbon. In this respect the carbon in the coating 6 reacts to some degree with the silicon in the applied layer and/or to some degree with the residual silicon present in the substrate of the faceplate 1 in the matrix of the faceplate 1 to form silicon carbide. The diffusion processes between the silicon in the substrate of the faceplate 1 and the carbon in the coating 6 result in a contact reaction through formation of silicon carbide, thus resulting in a permanent bonding of the coating 6 to the faceplate 1. The result is the formation of a monolithic structure. The silicon carbide present in the coating 6 guarantees that during the thermal process a very dense surface layer is formed that can be obtained due to the optimized distribution of particle size. With a suitable choice of the material system of the slurry it can be achieved during the thermal process that the layer that forms does not exhibit any porosity, thus exhibits neither an open nor closed porosity and thus the coating 6 does not exhibit any voids. After the end of this thermal process, the coated faceplate 1 can be polished with processing machines suitable for optical applications.

The reflector of the present invention has several advantages. Examples include reduced cost of manufacture compared to, for example, the relatively complicated milling technique for the rear side of the reflector because, compared to other methods, the application of the C/SiC foam is simple. The monolithic connection of the foam to its faceplate is done in a simple manner during and together with the Si infiltration of the faceplate.

Also, it is possible to obtain an extremely low weight per unit area of less than 15 kg/m², in particular of less than 10 kg/m² using the present invention. Due to the monolithic structure of the entire reflector, there are no different layers of material with different thermal properties, that is, there is no risk of the different layers of material detaching from each other or of a formation of cracks owing to the different expansion properties.

The use of a porous foam structure 2 results in better thermal transfer from the faceplate 1 into the ceramic material 2 or to a thermostating medium (for example, air or liquid), which can be fed to the ceramic material 2 so as to flow through it. If heat, which is introduced into the faceplate 1 of the reflector, for example, through the impingement of high radiation power on the surface of the reflector, is supposed to be dissipated, there can ensue, in particular, active cooling, for example, through air blown in rearwards or through a liquid coolant that is introduced. The result is that the heat transferred to the air, blown through a foam structure 2, is ten times higher than for a reflector structure without foam or comparable porous material. This is because the internal surface of the foam structure 2 is very much larger than the surface around which air or a similar coolant can flow, when there is no foam structure 2 or similar porous structure.

Another benefit of the present invention is the avoidance of the quilting effect. The previously described quilting effect, which is typical for the conventional structures with reinforcing ribs, can be avoided by designing the ceramic material as a porous foam structure.

The described solid ceramic C/SiC lightweight reflector can be used in particular as an element for optical equipment, for example telescopes or the like, for example in aerospace engineering.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations falling within the scope of the appended claims and equivalents thereof.

We claim:

1. A reflector, comprising:
a ceramic material of C/SiC foam with a low weight per unit area;
wherein the ceramic material is applied on a first surface of a ceramic C/SiC faceplate preformed in accordance with the reflector contour; and
wherein the ceramic material is connected monolithicly to the faceplate.

2. A reflector according to claim 1, further comprising at least one elevation made of C/SiC or depression made of C/SiC on a first surface of said faceplate.

3. A reflector according to claim 2, wherein said at least one elevation or depression are rib structures or channel structures.

4. A reflector according to claim 1, wherein heat is exchanged between the C/SiC foam and a thermostating medium.

5. A reflector according to claim 2, wherein heat is exchanged between the C/SiC foam and a thermostating medium.

6. A reflector according to claim 3, wherein heat is exchanged between the C/SiC foam and a thermostating medium.

7. A reflector according to claim 1,
wherein a C/SiC backplate is applied on the C/SiC foam; and
wherein the C/SiC backplate is connected monolithically to the C/SiC foam.

8. A reflector according to claim 1,
wherein a grindable and polishable surface coating is applied on the C/SiC faceplate; and
wherein the surface coating is connected monolithically to the C/SiC faceplate.

9. A process for manufacturing a reflector, comprising:
applying a C/SiC ceramic material with a low weight per unit area on a first surface of a C/SiC faceplate preformed in accordance with the reflector contour; and
monolithically connecting said ceramic material to said faceplate, and
pyrolyzing said foam in the absence of oxygen to produce a ceramic intermediate product with a foam structure; and
wherein said applying comprises coating a polymeric foam structure with a suspension comprising a silicon-containing ceramic starting material; and
wherein said connecting comprises infiltrating said ceramic material at temperatures exceeding 1,350° C.

10. A process according to claim 9, further comprising producing at least one C/SiC elevation or C/SiC depression on said faceplace prior to the applying step.

11. A process according to claim 9, further comprising applying a carbon/carbon backplate to and monolithically connecting said carbon/carbon backplate through infiltration with said foam structure prior to said infiltrating.

12. A process according to claim 9, further comprising:
applying a grindable and polishable surface coating on said faceplate; and
monolithically connecting said surface coating to said faceplate.

13. A process according to claim 9, wherein said suspension comprising a silicon-containing ceramic starting material is a suspension of SiC, silicon and carbon in an organic liquid mixture.

14. A reflector, comprising:
a preformed C/SiC faceplate; and
a C/SiC foam ceramic material monolithically connected to a first surface of said faceplate,
wherein said foam has a low weight to unit area ratio.

15. A reflector according to claim 15, wherein said first surface of said faceplate has at least one elevation or depression.

16. A reflector according to claim 15, further comprising a surface coating on a second surface of said faceplate.

17. A reflector according to claim 15, wherein said monolithic connection is achieved through the use of an adhesive.

18. A reflector according to claim 15, wherein the reflector weight per unit area is <15 kg/m².

19. A reflector according to claim 19, wherein the reflector weight per unit area is <10 kg/m².

20. A reflector according to claim 15, further comprising a C/SiC backplate, wherein a first side of said backplate is monolithically connected to said foam substantially opposite said faceplate.

21. A reflector according to claim 21, wherein said first surface of said backplate has at least one elevation or depression.

22. A reflector according to claim 21, wherein said monolithic connection is achieved through the use of an adhesive.

23. A method of making a reflector, comprising:
producing a ceramic foam by means of a polymeric structure;
pyrolizing said foam structure in the absence of oxygen;
connecting a first surface of said foam to a first surface of a faceplate to form a reflector; and
infiltrating said reflector with Si.

24. A method of making a reflector according to claim 24, wherein a second surface of said faceplate is shaped as a desired surface contour.

25. A method of making a reflector according to claim 24, wherein said connecting comprises the use of an adhesive.

26. A method of making a reflector according to claim 24, wherein said infiltrating step is performed at a temperature between 1350° C. and 1700° C., inclusive.

27. A method of making a reflector according to claim 24, further comprising the steps of:
coarsely grinding a second surface of said faceplate;
cleaning said second surface of said faceplate; and
coating said second surface of said faceplate.

28. A method of making a reflector according to claim 24, wherein the reflector weight per unit area is <15 kg/m².

29. A method of making a reflector according to claim 29, wherein the reflector weight per unit area is <10 kg/m².

30. A method of making a reflector according to claim 24, further comprising the step of connecting a second surface of said foam to a first surface of a backplate, wherein said second surface of said foam is substantially opposite said first surface of said foam.

31. A method of making a reflector according to claim 31, wherein said connecting comprises the use of an adhesive.

32. A method of making a reflector according to claim 31, wherein said infiltrating step is performed at a temperature between 1350° C. and 1700° C., inclusive.

33. A method of making a reflector according to claim 31, wherein the reflector weight per unit area is <15 kg/m².

34. A method of making a reflector according to claim 34, wherein the reflector weight per unit area is <10 kg/m².
